(19) United States
(12) Patent Application Publication
(10) Pub. No.: US 2020/0019954 A1
(43) Pub. Date: Jan. 16, 2020

(54) COMPUTER-IMPLEMENTED METHODS, SYSTEMS, AND COMPUTER-READABLE MEDIA FOR FACILITATING PAYMENTS AT PRIVATE EVENTS

(71) Applicant: Mastercard International Incorporated, Purchase, NY (US)

(72) Inventors: Juan Edward Black, St. Charles, MO (US); Brian A. Williams, St. Peters, MO (US); Christopher Eric Mullen, St. Peters, MO (US); Richard B. Unnerstall, O'Fallon, MO (US)

(73) Assignee: Mastercard International Incorporated, Purchase, NY (US)

(21) Appl. No.: 16/033,519

(22) Filed: Jul. 12, 2018

(51) Int. Cl. G06Q 20/32; G06Q 20/42

(52) U.S. Cl. CPC G06Q 20/3276; G06Q 20/42

(57) ABSTRACT

A computer-implemented method for facilitating a payment between merchants and consumers at a convention or other private, temporary event is implemented with a computer server programmed with pay application software. Profile information for at least one merchant and consumer, including identifying information and payment information, is received and stored in merchant and consumer portals. A purchase request identifying a product the consumer wishes to purchase is generated by an electronic device operated by the consumer while the consumer is attending the event. The purchase request is communicated to the server, which then retrieves transaction information related to the purchase request from the merchant and consumer portals. The pay application server then transmits the transaction information to a payment interchange, which transfers funds from the consumer to the merchant and sends payment confirmation back to the pay application server. The pay application server then notifies both the merchant and the consumer of the payment confirmation so that the merchant may provide the product to the consumer.

### FIELD OF THE INVENTION

The present disclosure generally relates to computer-implemented methods, systems, and computer-readable media for facilitating payments between merchants and consumers at conventions and other private, temporary events.

### BACKGROUND

Facilitating payments between merchants and consumers at conventions and other private, temporary events is challenging. Conventional point-of-sale (POS) systems and related credit card processing systems are effective, but they are designed for long-term use at conventional brick and mortar stores and are therefore typically too expensive and time-consuming to implement for short-term conventions and other private, temporary events. Electronic credit card transaction software and systems via smart phones and other mobile devices are less costly and time-consuming to implement, but such transaction systems introduce complexities and potential sources of error into payment processing flows. For example, variances between payment applications and/or native device software, transaction types, device manufacturers, carriers/network models, device capabilities, geographic locations, and other transaction parameters—plus the myriad versions of each that may be in use at any given time—make this technology challenging to implement for many private, temporary events. Another limitation of conventional payment processing systems, including the above-described POS systems and smart phone transaction systems, is their requirement for consumers to directly interact with merchants to make purchases. Such face-to-face interactions are not practical at many private, temporary events because the merchants are often busy demonstrating their products to others and the consumers are busy with other activities. Conventional payment systems also require consumers to carry their credit cards, debit cards, or cash with them, which is often not convenient at conventions and similar events.

This background discussion is intended to provide information related to the present invention which is not necessarily prior art.

### BRIEF SUMMARY

Embodiments of the present technology solve at least some of the above-described problems by providing a more practical and cost-effective way to transfer payments between merchants and consumers at conventions and other private, temporary events.

An embodiment of the technology comprises pay application software at least partially hosted on a server (pay application server) or other computer system that can only be accessed by merchants, consumers, and administrators at a convention or other private, temporary event. The pay application server includes or can access a merchant portal and a consumer portal on which merchant and consumer profiles may be stored. The pay application server is also coupled with or can otherwise access a payment interchange such as the Mastercard® interchange network or the Mastercard® Send API.

Merchants and consumers invited to attend an event access the merchant and consumer portals before the event to create and upload their profiles. Each merchant profile may include identifying information for a merchant; credit card information or other payment account information for the merchant; and identifying information for products offered for sale by the merchant. Likewise, each consumer profile may include identifying information for a consumer and credit card information or other payment information for the consumer.

Once the merchant and consumer profiles are created and stored, a consumer can request to purchase a product from a merchant by scanning a QR code on the product with an electronic device such as a smart phone or by opening a connection to the pay application server and selecting the desired product from the merchant's profile. The pay application server then accesses the merchant and consumer profiles to gather all necessary information to complete a payment transaction and transmits at least some of the information to the payment interchange. The payment interchange uses the transmitted transaction information to authorize and clear the transaction, after which it sends a confirmation to the pay application server. The pay application server then notifies the consumer and the merchant of the transaction completion so the parties can arrange transfer of the purchased product. The notifications may be provided in the merchant and consumer portals and/or may be pushed to electronic devices operated by the merchant and consumer via SMS messages or other direct communications. The notification to the merchant may include a photo of the consumer to assist with identification, and the notification to the consumer may include instructions on where and when to pick-up the purchased product so the transfer can be made at a convenient time and place.

Another embodiment of the technology comprises a computer-implemented method for facilitating a payment between a merchant and a consumer at a private, temporary event. The method may include the step of receiving in a merchant portal: identifying information for the merchant; payment information for the merchant; identifying information for products to be offered for sale by the merchant at the event; and price information for the products. The method may further comprise the step of receiving in a consumer portal: identifying information for the consumer and payment information for the consumer. The method may further comprise the step of receiving in a pay application server that is in communication with the merchant portal and the consumer portal a purchase request generated by an electronic device operated by the consumer while the consumer is attending the event and which identifies a product the consumer wishes to purchase. The method may further comprise the steps of transmitting transaction information related to the purchase request from the pay application server to a payment interchange; receiving payment confirmation at the pay application server; and notifying both the merchant and the consumer of the payment confirmation so that the merchant may provide the product to the consumer. The method may include additional, less, or alternate actions, including those discussed elsewhere herein.

Advantages of these and other embodiments will become more apparent to those skilled in the art from the following description of the exemplary embodiments which have been shown and described by way of illustration. The present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWING FIGURES

The Figures described below depict various aspects of methods, systems, and computer-readable media disclosed herein. Each Figure may depict an embodiment of a particular aspect of the disclosed inventions. Further, wherever possible, the following description refers to the reference numerals included in the following Figures, in which features depicted in multiple Figures are designated with consistent reference numerals. The disclosed embodiments are not limited to the precise arrangements and instrumentalities shown in the Figures.

FIG. 1 is a schematic diagram illustrating various components of an exemplary system which may be used for processing electronic payment transactions between merchants and consumers at a private, temporary event according to embodiments of the present invention;

FIG. 2 illustrates various components of an exemplary server shown in block schematic form that may be part of the system of FIG. 1 and that may host at least portions of the pay application software of the present invention;

FIG. 3 illustrates various components of an exemplary electronic device shown in block schematic form that may be used with the system of FIG. 1; and

FIG. 4 illustrates at least a portion of the steps of an exemplary computer-implemented method according to an embodiment of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, computer-implemented methods, computer systems, and computer software on computer-readable media for facilitating payments between merchants and consumers at private, temporary events. The events at which embodiments of the invention are most suited include private and temporary conventions, auctions, trade shows, and the like where merchants are invited to display and sell products and consumers are invited to view and possibly purchase products from the merchants. Use of the invention is not limited to any particular type of event, and embodiments of the invention may be used to facilitate payments between any merchants and consumers at any events.

An embodiment of the technology comprises pay application software at least partially hosted on a pay application server or other computer system that can only be accessed by merchants, consumers, and administrators invited to attend or participate in a convention or other private, temporary event. The pay application server includes or can access a merchant portal and a consumer portal. Merchants attending the event may access the merchant portal and create and store merchant profiles. Each merchant profile includes identifying information for a merchant, credit card information or other payment information for the merchant and identifying information for products to be offered for sale by the merchant. Likewise, consumers who will be attending the event may access the consumer portal to create and store consumer profiles. Each consumer profile may include identifying information for a specific consumer and credit card information or other payment information for the consumer.

The pay application server is also coupled with or can otherwise communicate with a payment interchange such as the Mastercard® interchange network or the Mastercard® Send API. The payment interchange receives information from the pay application server to complete a payment transaction as described below.

When a consumer attending an event wishes to purchase a product from a merchant, the consumer uses an electronic device to scan a QR code on the product or to open a connection to the pay application server via a web browser or phone app to select the desired product from the merchant's profile. The pay application server then accesses all necessary transaction information from the merchant and consumer portals to complete a payment transaction and transmits at least some of the information to the payment interchange. The payment interchange uses the transmitted transaction information to authorize and clear the transaction and then sends a confirmation to the pay application server.

The pay application server then notifies both the consumer and the merchant of the transaction clearance so the merchant can give the purchased product to the consumer. The notifications may be provided via the portals or the pay application server and/or or may be pushed to electronic devices operated by the merchant and consumer via SMS messages or other direct communications. The notification to the merchant may include a photo of the consumer to help with identification, and the notification to the consumer may include instructions on where and when to pick-up the purchased product so the transfer can be completed at a convenient time and place.

Specific embodiments of the technology will now be described in connection with the attached drawing figures. The embodiments are intended to describe aspects of the invention in sufficient detail to enable those skilled in the art to practice the invention. Other embodiments can be utilized, and changes can be made without departing from the scope of the present invention. The following detailed description is, therefore, not to be taken in a limiting sense. The scope of the present invention is defined only by the appended claims, along with the full scope of equivalents to which such claims are entitled.

### Exemplary System

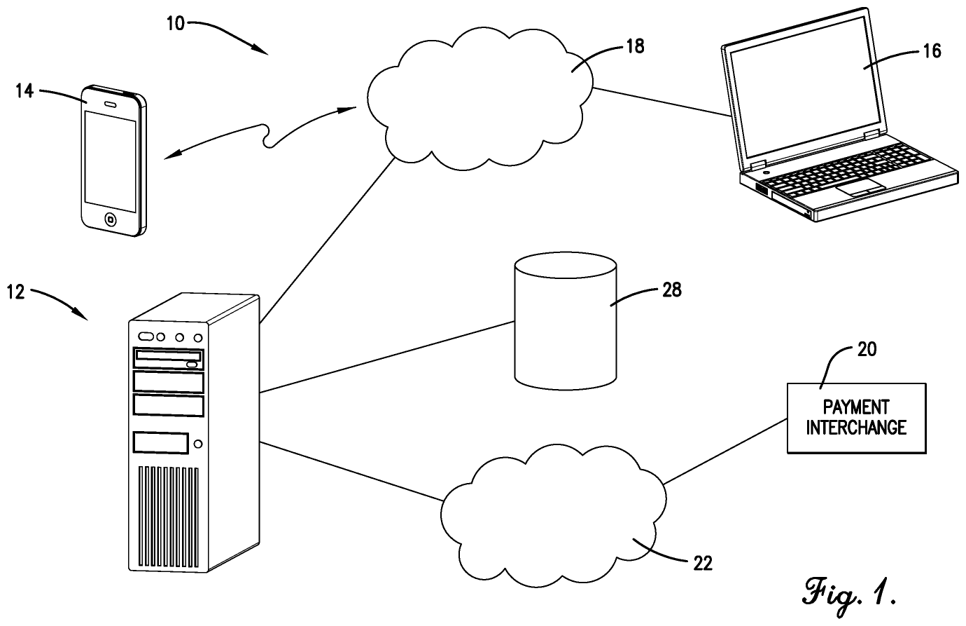

FIG. 1 depicts an exemplary system 10 that may be used to implement embodiments of the invention, including methods and software for processing electronic payment transactions at conventions and other private, temporary events. The system 10 broadly includes a server 12 that at least partially hosts pay application software, an electronic device 14 that may be operated by a consumer to access the server 12, and an electronic device 16 that may be operated by a merchant to access the server 12. The server 12 and electronic devices 14, 16 may exchange information and otherwise communicate via a communications link 18. The server 12 also communicates with a payment interchange 20 via a communications link 22. Although the system 10 illustrated in FIG. 1 only shows one electronic device 14 operated by a consumer and one electronic device 16 operated by a merchant, embodiments of the system 10 may include any number of such devices. Similarly, the system 10 may include any number of servers, communication links, and other hardware and/or software components.

The server 12 (also referred to herein as “pay application server”) receives and issues instructions and provides a user interface for receiving and transmitting information according to embodiments of the present invention, as discussed in more detail below. The server 12 also at least partially hosts pay application software, a merchant portal, and a consumer portal as described in more detail below.

The server 12 may be embodied by any number of application servers, database servers, file servers, gaming servers, mail servers, print servers, web servers, or the like, or combinations thereof. The server 12 may be configured to include or execute software such as file storage applications, database applications, email or messaging applications, web server applications, or the like, in addition to and/or in conjunction with the pay application software described herein.

The server 12 may apply business methods or algorithms, may utilize lookup tables or databases, receive user input via one or more peripheral devices or associated systems, or perform other tasks. The server 12 may perform such tasks in order to act as a secure gateway to receive and store merchant and consumer profile information and receive and transmit encrypted transaction data and other associated data, to observe and record certain details regarding each transaction, to forward transaction requests to the payment interchange 20, to encrypt and forward confirmations from the payment interchange 20 to electronic devices 14, 16, and to perform other functions in response to, for example, data elements included within transaction data.

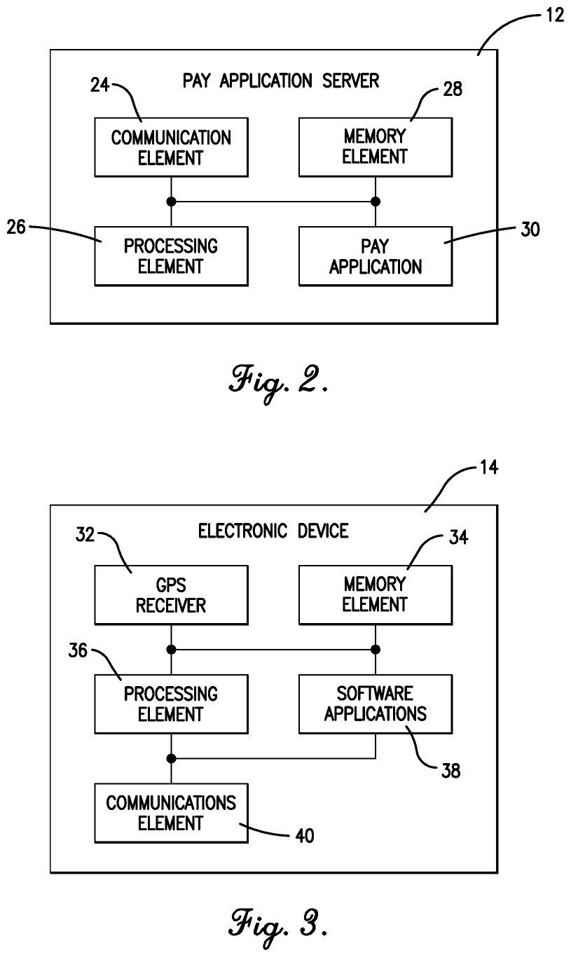

One exemplary embodiment of the pay application server 12 is shown in FIG. 2. The server 12 may include a communication element 24, a processing element 26, and a memory element 28 and is shown hosting the pay application software 30. The server 12 may be located anywhere, but at least a portion of the functionality of the server 12 is at least temporarily reserved for use in facilitating payments for a particular private, temporary event.

The communication element 24 allows data exchange and other communications with external systems or devices such as the electronic devices 14, 16 and the payment interchange 20. The communication element 24 may include signal or data transmitting and receiving circuits, such as antennas, amplifiers, filters, mixers, oscillators, digital signal processors (DSPs), and the like. The communication element 24 may establish communication wirelessly by utilizing RF signals and/or data that comply with communication standards such as cellular 2G, 3G, 4G, or 5G, IEEE 802.11 standard such as WiFi, IEEE 802.16 standard such as WiMAX, Bluetooth™, or combinations thereof. Alternatively, or in addition, the communication element 24 may establish communication through connectors or couplers that receive metal conductor wires or cables which are compatible with networking technologies such as ethernet. In certain embodiments, the communication element 24 may also couple with optical fiber cables. The communication element 24 is also in communication with or electronically coupled to the memory element 28 and/or the processing element 26.

The processing element 26 may include processors, microprocessors, microcontrollers, DSPs, field-programmable gate arrays (FPGAs), analog and/or digital application-specific integrated circuits (ASICs), or the like, or combinations thereof. The processing element 26 may generally execute, process, or run the pay application and/or other instructions, code, code segments, software, firmware, programs, applications, apps, processes, services, daemons, or the like. The processing element 26 may also include hardware components, such as finite-state machines, sequential and combinational logic, and other electronic circuits that may perform the functions necessary for the operation of embodiments of the current inventive concept. The processing element 26 may be in communication with the other electronic components through serial or parallel links that include address busses, data busses, control lines, and the like.

The memory element 28 may include data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, USB ports, or the like, or combinations thereof. The memory element 28 may include, or may constitute, a “computer-readable medium.” The memory element 28 may store the pay application software and/or other instructions, code, code segments, software, firmware, programs, applications, apps, services, daemons, or the like that are executed by the processing element 26. The memory element 28 may also store settings, data, documents, databases, and the like, including the merchant and consumer portals discussed herein.

The memory element 28 may store merchant and consumer information, including all information associated with the merchant and consumer portals, in one or more databases as depicted in FIG. 1. Any such databases may include a single database having separated sections or partitions or may include multiple databases, each being separate from each other. The databases may also store transaction data generated as part of sales activities relating to merchants, consumers, issuers, acquirers, and purchases made. The databases may also store consumer profile data and merchant profile data including the information described herein. The databases may also store purchase data associated with items being purchased by a consumer from a merchant, and authorization request data. The databases may also store “virtual stores” for each merchant, including picture files associated with products for sale by a merchant, price information, description, shipping and delivery information, instructions for facilitating a transaction, and other information to facilitate processing according to the methods described in the present disclosure.

The electronic devices 14, 16 are operated by consumers and/or merchants at an event and may be embodied by smart watches, smart phones, personal digital assistants (PDAs), tablets computers, palmtop or laptop computers, notebook computers, netbook computers, smart glasses, wearable and non-wearable electronics (e.g., any IoT devices), or any other electronic devices. Selected components of an exemplary electronic device 14 are shown in FIG. 3 and may include a GPS receiver element 32, a memory element 34, a processing element 36, software applications 38, and a communications element 40. The components of the electronic devices 14, 16 including the communication element 40, processing element 36, and memory element 34—operate and are constructed according to similar principles and with similar components to those set forth above with respect to analogous components of the server 12. The GPS receiver 32 may operate according to known principles for GPS receivers and/or chips common to smartphones, for example. The memory element 34 may store parts of the pay application software or software applications 38 configured to interact with the pay application software, and the processing element 36 may execute the software applications.

The communication links 18 and 22 allow communication between the server 12 and the electronic devices 14, 16 and between the server 12 and the payment interchange 20. The communication links 18, 22 may include local area networks, metro area networks, wide area networks, cloud networks, the Internet, cellular networks, plain old telephone service (POTS) networks, and the like, or combinations thereof. The communication links 18, 22 may be wired, wireless, or combinations thereof and may include components such as modems, gateways, switches, routers, hubs, access points, repeaters, towers, and the like. For example, the electronic devices 14, 16 may generally connect to the communication link 18 wirelessly, such as radio frequency (RF) communication using wireless standards such as cellular 2G, 3G, 4G, or 5G, Institute of Electrical and Electronics Engineers (IEEE) 802.11 standards such as WiFi, IEEE 802.16 standards such as WiMAX, Bluetooth®, or combinations thereof.

In some embodiments, the communications links 18, 22 are separate, but in other embodiments they are parts of the same communications network. For example, in one embodiment, the communications link 18 is a wireless, private, local area network and the communications link 22 is the Internet, but in other embodiments both communications links are part of the same local area network.

The devices of the system 10 preferably communicate via secure and/or encrypted communication means. For example, all or some of the devices may utilize Mutual Secure Sockets Layer (MSSL) technology for authenticating and exchanging transmissions. The system 10 may also use enterprise-standard encryption to secure communications.

The pay application software 30 and all its features and functionalities are embodied in the form of computer-executable instructions embodied in a computer-readable medium such as the memory element 28 and/or the memory element 34. The pay application software 30 may be hosted by the pay application server 12 or a computer system in communication with the server 12 and may include mobile applications that may be downloaded and installed on the electronic devices 14 and 16. The pay application software and its features and processes are not limited to the specific embodiments described herein. In addition, components of the system 10 can be practiced independent and separate from the pay application software 30 and other components and processes described herein. Each component and process can also be used in combination with other systems and processes.

The payment interchange 20 may comprise or interact with a transaction card system, such as a credit card payment system using the MasterCard® interchange network and/or the MasterCard® Send API. The MasterCard® interchange network and MasterCard® Send API are sets of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.). As used herein, financial transaction data includes a unique account number associated with a merchant, consumer, or other account holder using a payment card issued by an issuer, purchase data representing a purchase made by the cardholder, including a type of merchant, amount of purchase, date of purchase, and other data, which may be transmitted between any parties of multi-party transactions.

Aspects of a conventional transaction card system will now be summarized and contrasted with embodiments of the present invention. In a typical transaction card system, a financial institution called the “issuer” issues a transaction card, such as a credit card, to a consumer or cardholder, who uses the transaction card to tender payment for a purchase from a merchant. To accept payment with the transaction card, merchant must normally establish an account with a financial institution that is part of the financial payment system. This financial institution is usually called the “merchant bank,” the “acquiring bank,” or the “acquirer.” When cardholder tenders payment for a purchase with a transaction card, merchant requests authorization from a merchant bank for the amount of the purchase. The request may be performed over the telephone but is usually performed using a point-of-sale terminal, which reads cardholder's account information from a magnetic stripe, a chip, or embossed characters on the transaction card and communicates electronically with the transaction processing computers of merchant bank. Alternatively, merchant bank may authorize a third party to perform transaction processing on its behalf. In this case, the point-of-sale terminal will be configured to communicate with the third party. Such a third party is usually called a “merchant processor,” an “acquiring processor,” or a “third party processor.”

Using the payment interchange 20, computers of merchant bank or merchant processor will communicate with computers of an issuer bank to determine whether cardholder's account is in good standing and whether the purchase is covered by cardholder's available credit line. Based on these determinations, the request for authorization will be declined or accepted. If the request is accepted, an authorization code is issued to merchant.

When a request for authorization is accepted, the available credit line of cardholder's account is decreased. Normally, a charge for a payment card transaction is not posted immediately to cardholder's account because bankcard associations, such as MasterCard International Incorporated®, have promulgated rules that do not allow merchant to charge, or “capture,” a transaction until goods are shipped or services are delivered. However, with respect to at least some debit card transactions, a charge may be posted at the time of the transaction. When merchant ships or delivers the goods or services, merchant captures the transaction by, for example, appropriate data entry procedures on the point-of-sale terminal. This may include bundling of approved transactions daily for standard retail purchases. If cardholder cancels a transaction before it is captured, a “void” is generated. If cardholder returns goods after the transaction has been captured, a “credit” is generated. Interchange network and/or issuer bank stores the transaction card information, such as, and without limitation, a type of merchant, a merchant identifier, a location where the transaction was completed, an amount of purchase, and a date and time of the transaction, in a database.

After a purchase has been made, a clearing process occurs to transfer additional transaction data related to the purchase among the parties to the transaction, such as merchant bank, interchange network, and issuer bank. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction.

For debit card transactions, when a request for a personal identification number (PIN) authorization is approved by the issuer, cardholder's account is decreased. Normally, a charge is posted immediately to cardholder's account. The payment card association then transmits the approval to the acquiring processor for distribution of goods/services or information, or cash in the case of an automated teller machine (ATM).

After a transaction is authorized and cleared, the transaction is settled among merchant, merchant bank, and issuer bank. Settlement refers to the transfer of financial data or funds among merchant's account, merchant bank, and issuer bank related to the transaction. Usually, transactions are captured and accumulated into a “batch,” which is settled as a group. More specifically, a transaction is typically settled between issuer bank and interchange network, and then between interchange network and merchant bank, and then between merchant bank and merchant.

Embodiments of the present invention use the payment interchange 20 in a different way. Instead of presenting a credit card to a merchant when purchasing a product, a consumer stores his or her credit card information in a consumer profile via the consumer portal. Likewise, the merchant stores all its payment account information in a merchant profile via the merchant portal. When a purchase request is generated by the consumer via the electronic device 14, the pay application server 12 gathers credit card information for the consumer and payment information for the merchant from the consumer and merchant profiles and transmits this transaction information to the payment interchange 20. The payment interchange 20 then processes the transaction and sends confirmation information back to the pay application server, which then notifies the merchant and consumer. More detailed descriptions of embodiments of this invention are described below.

### Exemplary Computer-Implemented Method

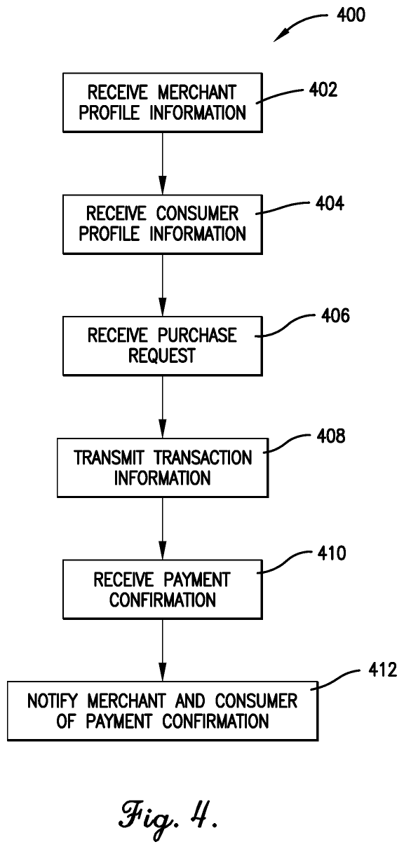

FIG. 4 depicts steps of an exemplary computer-implemented method 400 for facilitating payments between a consumer and a merchant at a convention or other private, temporary event. Some steps may be performed concurrently as opposed to sequentially and may in some cases be performed in a different order. In addition, some steps may be optional, and other steps may be added. The computer-implemented method 400 is described below, for ease of reference, as being executed by exemplary devices and components introduced with the embodiments illustrated in FIGS. 1-3. For example, the steps of the computer-implemented method 400 may be performed by the server 12, the pay application software 30 hosted on the server, the electronic devices 14, 16, and/or the payment interchange 20. However, responsibility for all or some of such actions may be distributed differently among such devices or other computing devices without departing from the spirit of the present invention.

In particular embodiments, at least some of the steps of the method 400 are performed by one or more computer-readable medium(s). The computer-readable medium(s) may store the pay application software 30 thereon, and the pay application software 30 may instruct one or more of the devices of the system 10 to perform all or certain of the steps outlined herein. The pay application software 30 and/or other program(s) stored on the computer-readable medium(s) may instruct the system 10 to perform additional, fewer, or alternative actions, including those discussed elsewhere herein.

For the sake of brevity and clarity, descriptions of well-known electronic transaction technology and data, including those described above, will be generally avoided here. As a particular example, the structure, function and/or use of technology and data commonly associated with electronic credit card transactions should be understood to apply to the embodiments of the present invention outlined hereinbelow except as otherwise described in or fairly understood from this disclosure. However, certain otherwise generally known technology or data—such as hardware, software or processes—may be described herein, for instance in cases where the structure, function and/or use are considered related to and/or are altered under novel aspects of embodiments of the present invention.

Turning now to FIG. 4, the method 400 begins when at least one merchant and at least one consumer attending a convention or other private, temporary event upload profile information to the server 12 as depicted in steps 402 and 404. In some embodiments, merchants and consumers may access merchant and consumer portals hosted on, or in communication with, the server 12 to create and store merchant and consumer profiles in the portals. The profiles may be created at any time, but are preferably created and stored before the event begins, such as during registration for the event. The merchants and consumers may upload this information to the server 12 by using the electronic devices 14, 16 or any other devices. In some embodiments, the electronic devices 14, 16 connect to the server 12 with web browsers that establish connections via the communications link 18. In other embodiments, the electronic devices 14, 16 include resident applications that interact with the pay application software 30 on the server 12.

The merchant and consumer profiles may include any information that facilitates payment transactions for products purchased at the event. In one embodiment, each merchant profile includes identifying information such as the merchant's name, address, phone number, web address, email address, and location at the event. The identifying information may also include photos of employees or other representatives of the merchant. Each merchant profile also includes payment information for the merchant, such as instructions for settling transactions, including merchant bank account information. Each merchant profile may also include a “virtual store” that includes key-words and other searchable information for products offered for sale by the merchant at the event, picture files associated with the products, price information for the products, pick-up and/or delivery information, and any other information that facilitates purchases and payment processing according to the methods described in the present disclosure.

Similarly, each consumer profile may include identifying information for a consumer attending the event, such as the consumer's name, address, phone number, and email address. The identifying information may also include a photo of the consumer. Each consumer profile may also include payment information for the consumer, instructions for settling transactions, credit card information, and bank account information.

The merchant and consumer profiles may also store purchase data associated with items being purchased by a consumer from a merchant, payment authorization data, and similar transaction data. Although the merchant and consumer portals and profiles are described herein as being separate, they may be combined into a single portal or other user interface and/or memory element.

The method further comprises the step of receiving a purchase request from a consumer as depicted in step 406. The purchase request identifies a product the consumer wishes to purchase and may be generated when the consumer scans a QR code or other identifying information associated with a product or when the consumer access the merchant's virtual store via a web browser on the electronic device 14 and selects a product to purchase from the virtual store. Some embodiments of the invention may use geo-fencing techniques to assist with purchase requests. For example, the coordinates of each merchant's physical presence at the event may be stored in the pay application server, and when a consumer's electronic device 14 is near the merchant, as determined by the GPS receiver 32 in the device 14, photos, prices, and other information about the merchant's products may be pushed to the electronic device 14.

Once a purchase request is generated by any of the methods described above and/or other methods, the purchase request is transmitted to or otherwise conveyed to the pay application server 12. In some embodiments, the consumer may be required to enter a password, scan a thumbprint, or complete a face ID to authorize a purchase request before its sent. The method then comprises the step of retrieving and transmitting transaction information related to the purchase request from the pay application server 12 to the payment interchange 20 as shown in step 408. The transmitted transaction information may include the consumer's name and credit card number and the merchant's name, bank account information, and/or credit card number. In one embodiment, the pay application server 12 accesses all transaction information necessary to transfer funds from the consumer to the merchant from the merchant and consumer portals and sends such information to the payment interchange 20 via the communication link 22 or other communication link. The payment interchange 20 then transfers funds from the consumer to the merchant in the manner described above.

Once the payment interchange 20 settles funds between the consumer and merchant, it sends payment confirmation to the pay application server 12 as shown in step 410. The payment confirmation may be similar to confirmations provided in conventional credit card payment transactions and is preferably automatically sent to the server 12 once the payment interchange 20 transfers funds from the consumer's account to the merchant's account.

The method further comprises the step of notifying both the merchant and the consumer of the payment confirmation as shown in step 412 so the merchant may provide the product to the consumer. The notifications may be provided on the pay application server 12 or may be pushed to the electronic devices 14, 16 operated by the merchant and consumer via SMS messages or other direct communications. The notification to the merchant may include a photo of the consumer to help identify the consumer in a crowd, and the notification to the consumer may include instructions on where and when to pick-up the purchased product so the transfer can be made at a convenient time and place. In some embodiments, the notification to the consumer may provide delivery options, such as in-person pick-up, shipment by mail, etc., that the consumer may choose between. The merchant may then be notified of the consumer's selected delivery option via the merchant portal or a via a pushed message.

The method may include additional, less, or alternate actions, including those discussed elsewhere herein.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, later, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. A computer-implemented method for facilitating a payment between a merchant and a consumer at a private event, the computer-implemented method comprising:
receiving in a merchant portal: identifying information for the merchant, payment information for the merchant, identifying information for products to be offered for sale by the merchant at the private event, and price information for the products;
receiving in a consumer portal: identifying information for the consumer and payment information for the consumer;
receiving in a pay application server that is in communication with the merchant portal and the consumer portal a purchase request generated by an electronic device operated by the consumer while the consumer is attending the private event, the purchase request identifying a product offered for sale by the merchant that the consumer wishes to purchase;
transmitting transaction information related to the purchase request from the pay application server to a payment interchange;
receiving payment confirmation at the pay application server from the payment interchange; and
notifying both the merchant and the consumer of the payment confirmation via the pay application server so the merchant may provide the product to the consumer.

2. The computer-implemented method of claim 1, wherein the payment interchange processes a payment from the consumer to the merchant based at least partially on the transaction information transmitted to the payment interchange.

3. The computer-implemented method of claim 1, wherein the merchant portal and consumer portal are hosted on the pay application server, and wherein the pay application server is a private web server that is accessible only by the merchant, the consumer, other merchants and consumers at the private event and administrators of the event.

4. The computer-implemented method of claim 3, wherein the pay application server is accessible via web browsers on the electronic device operated by the consumer and an electronic device operated by the merchant.

5. The computer-implemented method of claim 1, wherein the purchase request is generated by the electronic device operated by the consumer and sent to the pay application server when the consumer uses the electronic device to scan a QR code associated with the product.

6. The computer-implemented method of claim 1, wherein the purchase request is generated by the electronic device operated by the consumer and sent to the pay application server when the consumer accesses the merchant portal and selects a product the consumer wishes to purchase from the identifying information for the products on the merchant portal.

7. The computer-implemented method of claim 1, wherein the transaction information transmitted to the payment interchange specifies at least one of: (A) the payment information for the merchant, (B) the payment information for the consumer, and (C) the price information for the product subject to the purchase request.

8. The computer-implemented method of claim 1, wherein the private event is a convention.

9. The computer-implemented method of claim 1, wherein the identifying information for the merchant includes a name of the merchant and a tax ID for the merchant, and wherein the identifying information for the consumer includes a name of the consumer and a photo of the consumer.

10. The computer-implemented method of claim 1, wherein the notifying step includes sending the photo of the consumer to the merchant.

11. A computer system for facilitating a payment between a merchant and a consumer at a private event, the computer system comprising:
a merchant portal in which is stored identifying information for the merchant, payment information for the merchant, identifying information for products to be offered for sale by the merchant at the private event, and price information for the products;
a consumer portal in which is stored identifying information for the consumer and payment information for the consumer;
a pay application server in communication with the merchant portal and the consumer portal and programmed to:
receive a purchase request generated by an electronic device operated by the consumer while the consumer is attending the private event, the purchase request identifying a product the consumer wishes to purchase;
transmitting transaction information related to the purchase request from the pay application server to a payment interchange;
receiving payment confirmation at the pay application server from the payment interchange; and
notifying both the merchant and the consumer of the payment confirmation via the pay application server so that the merchant may provide the product to the consumer.

12. The computer system of claim 11 wherein the merchant portal and consumer portal are hosted on the pay application server, and wherein the pay application server is a private web server that is accessible only by the merchant, the consumer, other merchants and consumers at the private event and administrators of the event.

13. The computer system of claim 12, wherein the pay application server is accessible via web browsers on the electronic device operated by the consumer and an electronic device operated by the merchant.

14. The computer system of claim 11, wherein the purchase request is generated by the electronic device operated by the consumer and sent to the pay application server when the consumer uses the electronic device to scan a QR code associated with the product.

15. The computer system of claim 11, wherein the purchase request is generated by the electronic device operated by the consumer and sent to the pay application server when the consumer accesses the merchant portal and selects a product the consumer wishes to purchase from the identifying information for the products on the merchant portal.

16. The computer system of claim 11, wherein the transaction information transmitted to the payment interchange specifies at least one of: (A) the payment information for the merchant, (B) the payment information for the consumer, and (C) the price information for the product subject to the purchase request.

17. The computer system of claim 11, wherein the private event is a convention.

18. The computer system of claim 11, wherein the identifying information for the merchant includes a name of the merchant and a tax ID for the merchant, and wherein the identifying information for the consumer includes name of the consumer and a photo of the consumer.

19. A computer-implemented method for facilitating a payment between a merchant and a consumer at a convention, the computer-implemented method comprising:
receiving in a merchant portal before the convention commences: identifying information for the merchant, payment information for the merchant, identifying information for products to be offered for sale by the merchant at the convention, price information for the products, and pick-up instruction for purchased products;
receiving in a consumer portal before the convention commences: identifying information for the consumer, including a photo of the consumer, and payment information for the consumer;
receiving in a pay application server that is in communication with the merchant portal and the consumer portal a purchase request generated by an electronic device operated by the consumer while the consumer is attending the convention, the purchase request identifying a product offered for sale by the merchant the consumer wishes to purchase;
transmitting transaction information related to the purchase request from the pay application server to a payment interchange;
receiving payment confirmation at the pay application server from the payment interchange; and
notifying both the merchant and the consumer of the payment confirmation via the pay application server so the merchant may provide the product to the consumer, the notifying step including sending the photo of the consumer to the merchant and sending the pick-up instructions to the consumer.

20. The computer-implemented method of claim 19, wherein the payment interchange processes a payment from the consumer to the merchant based at least partially on the transaction information transmitted to the payment interchange.
